(19) United States
(12) Patent Application Publication
(10) Pub. No.: US 2012/0113810 A1
(43) Pub. Date: May 10, 2012

(54) TOLL-BASED ROUTING

(75) Inventors: Don Reed Brown, Salt Lake City, UT (US); Douglas M. Erickson, Centerville, UT (US); Robert B. Raver, Murray, UT (US)

(73) Assignee: Tell Radius, L.C., Salt Lake City, UT (US)

(21) Appl. No.: 13/175,018

(22) Filed: Jul. 1, 2011

Related U.S. Application Data
(60) Provisional application No. 61/360,771, filed on Jul. 1, 2010.

(51) Int. Cl. H04L 12/26

(52) U.S. Cl. 370/238

(57) ABSTRACT

A method for toll-based routing is described. A routing table that associates a cost and a quality factor with each destination in a network is built. One or more data packets are received. A neighboring node to send the one or more data packets is selected based on the routing table and user preferences of an originator or intended receiver of the one or more data packets. The one or more data packets are sent to the selected neighboring node. A routing report that indicates routing of the one or more data packets is sent to a toll service.

### RELATED APPLICATIONS

This application is related to and claims priority from U.S. Provisional Patent Application Ser. No. 61/360,771 filed Jul. 1, 2010, for “Toll-Based Routing,” which is incorporated herein by reference.

### TECHNICAL FIELD

The present disclosure relates generally to communication systems. More specifically, the present disclosure relates to toll-based routing.

### BACKGROUND

Communication systems are widely deployed to provide various types of communication content such as voice, video, data, and so on. These systems increase productivity in the workplace, help students to learn, and distribute an unprecedented amount of information.

As the Internet expands, many people are able to gain access to valuable information. However, the present structure of the Internet also creates potential problems. Major branches may be chokepoints, making major portions of the Internet susceptible to outages. For example, if a major branch is damaged, an entire community or even nation may experience a service outage. Furthermore, having few major branches allows for political censorship in some areas of the world.

Currently, only large companies and governments have the resources to route major portions of the Internet. However, if an incentive was designed correctly, a more robust and reliable Internet structure may arise. Therefore, benefits may be realized from systems and methods for toll-based routing.

### SUMMARY OF THE INVENTION

A method for toll-based routing is described. A routing table that associates a cost and a quality factor with each destination in a network is built. One or more data packets are received. A neighboring node to send the one or more data packets is selected based on the routing table and user preferences of an originator or intended receiver of the one or more data packets. The one or more data packets are sent to the selected neighboring node. A routing report that indicates routing of the one or more data packets is sent to a toll service.

In one configuration, payment may be received for routing the one or more data packets. In another configuration, the user preferences may be received from the toll service. The user preferences may indicate a preference for low-cost routing or high-speed routing. The routing report may include a data total of the one or more data packets from a most recently sent packet in the one or more data packets. The most recently sent packet may include a signature of an originator of the one or more data packets. The network may be a mesh network.

An apparatus for toll-based routing is also described. The apparatus includes a processor and memory in electronic communication with the processor. Executable instructions are stored in the memory. The instructions are executable to build a routing table that associates a cost and a quality factor with each destination in a network. The instructions are also executable to receive one or more data packets. The instructions are also executable to select a neighboring node to send the one or more data packets based on the routing table and user preferences of an originator or intended receiver of the one or more data packets. The instructions are also executable to send the one or more data packets to the selected neighboring node. The instructions are also executable to send a routing report to a toll service that indicates routing of the one or more data packets.

A method for toll-based routing is also described. A user account is created with user preferences for routing data to and from a user. User preferences are distributed to the toll-based router. A routing report that indicates routing of one or more data packets is received from the toll-based router. A payment report that indicates a payer for the routing of the one or more data packets, the toll-based router that is owed for the routing and an amount owed for the routing is sent to a payment system.

In one configuration, creating a user account may include directing a web browser of the user to a toll system web page, receiving input from the user about a payment method and receiving the user preferences for routing data to and from the user. The user preferences may indicate a preference for low-cost routing or high-speed routing. The routing report may include a most recently sent packet in the one or more data packets and a data total of the one or more data packets. The most recently sent packet may include a signature of an originator of the one or more data packets.

An apparatus for toll-based routing is also described. The apparatus includes a processor and memory in electronic communication with the processor. Executable instructions are stored in the memory. The instructions are executable to create a user account with user preferences for routing data to and from a user. The instructions are also executable to distribute the user preferences to the toll-based router. The instructions are also executable to receive a routing report from the toll-based router that indicates routing of one or more data packets. The instructions are also executable to send a payment report to a payment system that indicates a payer for the routing of the one or more data packets, the toll-based router that is owed for the routing, and an amount owed for the routing.

### BRIEF DESCRIPTION OF THE DRAWINGS

FIG. 1 is a block diagram of a system that uses toll-based routing;

FIG. 2 is a block diagram illustrating a toll-based router;

FIG. 3 is a flow diagram illustrating a method for toll-based routing;

FIG. 4 is a block diagram illustrating a toll service;

FIG. 5 is a flow diagram illustrating another method for toll-based routing;

FIG. 6 is a flow diagram illustrating another method for toll-based routing;

FIG. 7 is a sequence diagram illustrating the interactions between the components of a system that uses toll-based routing;

FIG. 8 is a flow diagram illustrating another method for toll-based routing;

FIG. 9 is a sequence diagram illustrating additional interactions between the components of a system that uses toll-based routing; and

FIG. 10 is a block diagram illustrating various components that may be utilized in a computing device.

### DETAILED DESCRIPTION

Toll-based routing may help provide Internet access that is fast, cheap, reliable and ubiquitous. It may allow participants in a network to receive payment for the network routing service they provide. For example, the network may be a mesh network. The resulting competition may foster the growth of a better network. As used herein, the term “mesh network” refers to a network of nodes where each node may route traffic to and from other nodes. Hence, in a mesh network, there may be two or more paths to any node. This may make the network more robust and economical to produce.

In order to route traffic successfully, a new routing protocol may be used. This routing protocol may be optimized for the relatively large number of possible routes available in a network and take cost and performance criteria into account in its routing decisions. For example, the number of possible routes in a mesh network may grow exponentially with each added node.

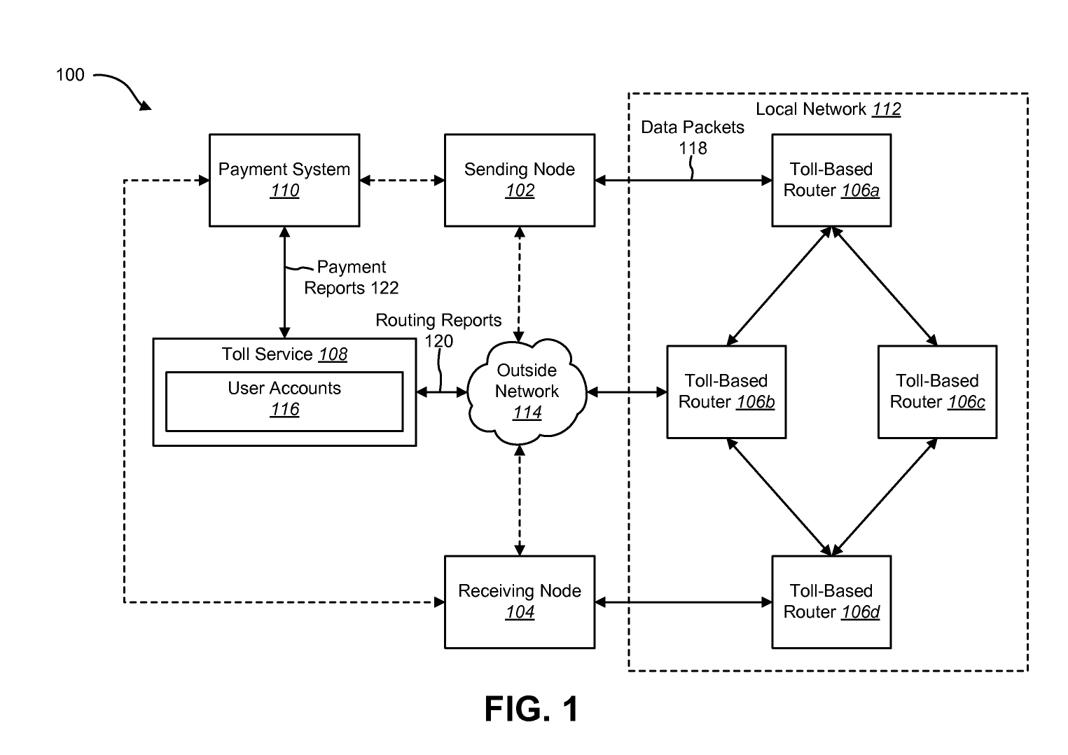

FIG. 1 is a block diagram of a system 100 that uses toll-based routing. The communication system 100 may be a wired or wireless communication system. The communication system 100 may include a sending node 102 and a receiving node 104. As used herein, the term “node” refers to any computing device capable of communicating with another computing device. For example, sending node 102 and receiving node 104 may be a personal computer, a mobile device such as a cell phone or a smartphone, a personal digital assistant (PDA), a tablet computer, etc. The sending node 102 may communicate with the receiving node 104 over a local network 112. In one configuration, the local network 112 may be a mesh network. In another configuration, the sending node 102 may communicate with the receiving node 104 using the local network 112 and an outside network 114.

The local network 112 may include multiple toll-based routers 106a-d. The toll-based routers 106a-d may be computing devices that direct packet communications using routing tables that account for the monetary cost and quality of different connections between different points in a communication path. For example, a first toll-based router 106a may receive data packets 118 intended for the receiving node 104. The first toll-based router 106a may use a routing table to determine whether to send the data packets 118 to a fourth toll-based router 106d via a second toll-based router 106b or a third toll-based router 106c. Specifically, user preferences from a user account 116 for the sending node 102 (or the receiving node 104) may be propagated through the local network 112 to the first toll-based router 106a. Then, based on the user preferences, the first toll-based router 106a may send the data packets 118 to the second toll-based router 106b or the third toll-based router 106c. The second toll-based router 106b or the third toll-based router 106c may then send the data packets 118 to the fourth toll-based router 106d also based on the user preferences. In this manner, the user preferences may be honored at each toll-based router 106a-d that routes data packets 118 for the user.

In one configuration, the sending node 102 may pay a fee to the first toll-based router 106a for the data packets 118 that the first toll-based router 106a routes on behalf of the sending node 102. The first toll-based router 106a may pay a fee to the next toll-based router 106b or 106c for the data packets 118 that the next toll-based router 106b or 106c routes on behalf of the first toll-based router 106a. The first toll-based router 106a may charge the sending node 102 a price per data packet 118 that is greater than the price per data packet 118 the first toll-based router 106a pays to the next toll-based router 106b or 106c. In this manner, the first toll-based router 106a may earn a profit routing data packets 118 for the sending node 102.

In one configuration, each link between toll-based routers 106a-d may have an associated cost and quality. For example, the second toll-based router 106b may charge 0.1 cents per kilobyte routed on a standard connection while the third toll-based router 106c may charge 0.12 cents per kilobyte routed for a faster connection. If the user preferences indicate that the sending node 102 (or the receiving node 104) prefers low-cost routing, the data packets 118 may be sent to the second toll-based router 106b. Alternatively, if the user preferences indicate that the sending node 102 (or the receiving node 104) prefers high-speed routing, even at extra expense, the data packets 118 may be sent to the third toll-based router 106c. Eventually, the data packets 118 may be received at the receiving node 104.

The toll-based routers 106a-d may then transmit routing reports 120 to a toll-service 108 at configurable intervals. The routing reports 120 indicate the routing performed for which the toll-based router 106a-d is to be paid. In one configuration, the routing reports 120 may be a summary of the routing performed, including information from a most recently sent packet of each transmission that includes the originating (or receiving) node's signature and the data total.

The toll service 108 may verify the routing report(s) 120 and submit a payment report 122 to a payment system 110. The payment report 122 may include a payee, a payer and an amount. The payment system 110 may aggregate many payment reports 122 and periodically receive and distribute payments to the participating nodes and toll-based routers 106a-d. The payment system 110 may charge a fee for this service. Although illustrated as separate entities, a toll-based router 106a-d may also be a sending node 102, a receiving node 104, or both.

For some transmissions, the sending node 102 may be responsible for paying any routing fees, e.g., the sender of an email may be responsible for payment. However, a receiving node 104 may be responsible for payment in other types of transmissions, e.g., streaming video. Alternatively, both the sending node 102 and receiving node 104 may be jointly responsible for payment, e.g., a Voice over IP (VoIP) conversation. If both the sending node 102 and receiving node 104 are jointly responsible for payment, the user preferences of the sending node 102 may be used by the toll-based routers 106a-d when determining where to route data packets 118. In another configuration, each node may be responsible for all traffic that the node sends and receives. In one configuration, each data packet 118 may contain information that indicates whether the sending node 102, the receiving node 104 or both is responsible for payment.

The local network 112 may communicate with the toll service 108 using an outside network 114. The outside network 114 may represent the Internet, one or more wide area networks (WANs), one or more local area networks (LANs), etc. The outside network 114 may be implemented using wired and/or wireless communication technologies and may use any available protocols to pass data between the various illustrated devices and entities. Furthermore, other outside networks 114 may be implemented throughout the system 100. For example, the first toll-based router 106a may communicate with the second toll-based router 106b using a wireless or cellular network, e.g., 802.11n, 802.11g, WiMAX, Long Term Evolution (LTE), etc Likewise, the payment system 110 may communicate using the Internet.

In one configuration, the local network 112 may represent a relatively small geographic location where each toll-based router 106a-d represents a home in a neighborhood. In this configuration, only a subset of the toll-based routers 106a-d may have access to an outside network 114. Therefore, the devices without direct access to the outside network 114 may access the outside network 114 via the toll-based routers 106a-d with direct access to the outside network 114, i.e., using toll-based routing. In other words, toll-based routing may allow a person within a local network 112 to be paid for the routing they perform. This may incentivize the building of large local networks 112, e.g., mesh networks.

When attempting to access the network, end users (e.g., a sending node 102) may be prompted to register with the toll service 108. A payment method may be established, i.e., a means for sending and receiving payment for toll-based routing. Customers may be provided with software that creates a new virtual network interface on their computer system. Network traffic over this interface may be measured and charged to the customer's user account 116 in the toll service 108. Customers may be charged for traffic they send, receive or both.

Service providers (e.g., toll-based routers 106a-d) may also register with the toll service 108 and specify a method to make and receive payments. After routing data packets 118 for end users, the toll-based routers 106a-d may communicate with the payment system 110 via the toll service 108 to request payment for conveying traffic.

Providers of routing service in the system 100 may send or receive traffic via other toll-based routers 106a-d. Alternatively, the toll-based routers 106a-d may act as a gateway between the local network 112 and the rest of the Internet, i.e., the outside network 114. When acting as a client to another toll-based router 106a-d, a toll-based router 106a-d may be treated like an end user and may be charged for its routing requests.

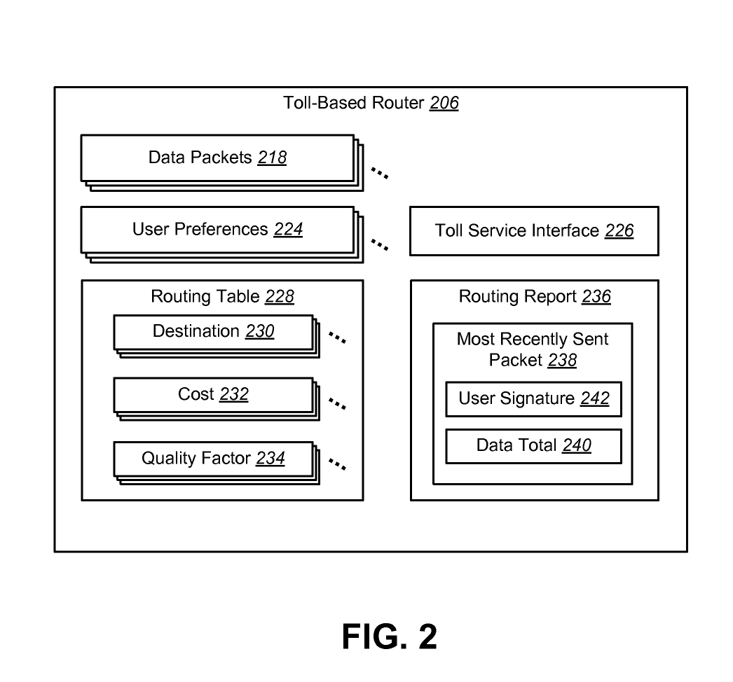

FIG. 2 is a block diagram illustrating a toll-based router 206. The toll-based router 206 may be a part of a local network 112. The toll-based router 206 may receive data packets 218 from a sending node 102 or another toll-based router 206. Based on user preferences 224 and a routing table 228, the toll-based router 206 may transmit the data packets 218 to either a receiving node 104 or another toll-based router (not shown). The user preferences 224 may be received from a toll service 108 and may indicate whether the user prefers low-cost or high-speed routing, i.e., whether the user prefers to pay more for a higher quality connection.

The routing table 228 may be included in each toll-based router 206 in a local network 112. The elements of the routing table 228 may be propagated to each toll-based router 206 within a local network 112, e.g., a toll-based router's 206 information may be broadcast to neighbors when powering on. The routing table 228 may include a cost 232 and a quality factor 234 for each destination 230 in a local network 112. Alternatively, or in addition to, the routing table 228 may include a cost 232 and quality factor 234 for each possible route to each destination 230, i.e., there may be multiple routes with different costs 232 and quality factors 234 for each destination 230. Alternatively, the routing table 228 may include a cost 232 and quality factor 234 per individual link within the local network 112.

In one configuration, the quality factor 234 in the routing table 228 for a destination 230 may be the quality factor 234 broadcast by the destination 230. In another configuration, the quality factor 234 may be estimated based on factors such as the physical transmission medium, the speed of communication equipment, past performance, etc. In another alternative, the toll-based router 206 may modify the quality factor 234 broadcast by the destination 230 based on user preferences, past performance, measurements of interference in the communications medium, etc.

After routing the data packets 218 based on the user preferences 224, the toll-based router 206 may account for the routing performed in order to be compensated. A toll-based routing system 100 may use cryptography to provide a “non-repudiation” capability to each data packet 218 that passes through the system 100, so that service providers (e.g., toll-based routers 206) can prove that a customer (e.g., sending node 102) agreed to pay for service. In one configuration, the sending node 102 may include a user signature 242 with each data packet 218. The user signature 242 may include an encrypted hash value of the data packet 218. The hash value may be calculated using a hash function.

In one configuration, the hash value may be encrypted using asymmetric or symmetric cryptography. In asymmetric cryptography, the sending node 102 may encrypt the hash value using the sending node's 102 private key. To verify the user signature 242, the toll service 108 may decrypt the hash value using the sending node's 102 public key. The toll service 108 may re-compute the hash value of the data packet 218 using the hash function. The toll service 108 may compare the re-computed hash value with the decrypted hash value. If the values match, then the toll service 108 may trust that the data packet 218 was sent by the sending node 102. If the values do not match, then the toll service 108 may detect a forgery. In symmetric cryptography, the toll service 108 may provide the sending node 102 a secret key when the sending node 102 creates a user account 116. The sending node 102 may encrypt the hash value using the secret key. To verify the user signature 242, the toll service may decrypt the hash value using the secret key, re-compute the hash value of the data packet 218 and compare the hash values as discussed above. In another configuration, a message authentication code may be used instead of an encrypted hash value.

In order to minimize the amount of information that is recorded and transmitted by the toll-based router 206 to receive payment, each new routing request may incorporate a summary of previous routing requests, i.e., a routing report 236. In this way, a toll-based router 206 may only record the most recent routing request.

Therefore, the routing report 236 may prove that a toll-based router 206 actually routed the data packets 218. In one configuration, the routing report 236 may include the part of a most recently sent packet 238 routed that includes the originating user's (or receiving user's) signature 242 and a data total 240. This may serve as a summary of routing performed without unnecessarily consuming bandwidth during reporting. Once generated, the toll-based router 206 may send the routing report 236 to a toll service 108 using a toll service interface 226.

In one configuration, the toll-based router 206 may be a specialized, stand-alone hardware device. Alternatively, the toll-based router 206 may implement a unique routing system that adheres to an existing system, communicating as necessary with the payment system 110 to collect tolls. The hardware used by toll-based routers 206 may use a variety of technologies for connectivity, including radio, optical, or electronic. The hardware may be a device dedicated to routing or part of multi-purpose hardware running other processes alongside the routing functionality.

A toll-based routing system 100 may also use cryptography to protect the privacy of data within the local network 112. This layer of encryption may be stripped from data packets 218 if they pass through a gateway onto the traditional Internet. However, the toll-based routing system 100 may not interfere with encryption performed at higher protocol levels, such as Internet Protocol Security (IPsec) or Transport Layer Security (TLS), which may remain intact through gateways.

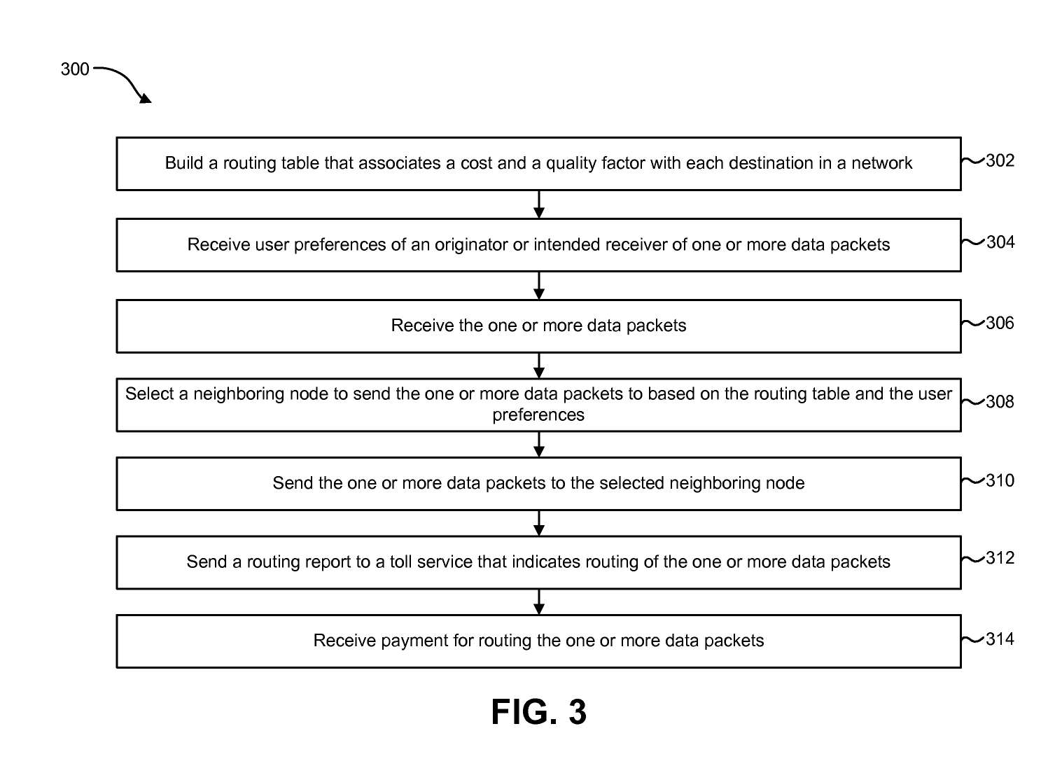

FIG. 3 is a flow diagram illustrating a method 300 for toll-based routing. The method 300 may be performed by a toll-based router 206. The toll-based router 206 may build 302 a routing table 228 that associates a cost 232 and a quality factor 234 with each destination 230 in a local network 112. Alternatively, the routing table 228 may include a cost 232 and a quality factor 234 for each route to a destination 230 or each link within the local network 112. The routing table 228 may be built using messaging within the local network 112. For example, a message may be sent to a toll-based router's 206 nearest neighbors when it powers up or powers down.

The toll-based router 206 may receive 304 user preferences 224 of an originator (e.g., sending node 102) or intended receiver (e.g., receiving node 104) of one or more data packets 218. The user preferences 224 may be received from a toll service 108 that stores user accounts 116 or directly from the user. The toll-based router 206 may also receive 306 one or more data packets 218, e.g., from a sending node 102 or another toll-based router 206 acting as an end user. The toll-based router 206 may also select 308 a neighboring node to receive the one or more data packets 218 based on the routing table 228 and user preferences 224 of an originator or intended receiver of the one or more data packets 218. This selection may be based on the cost 232, quality factor 234 or both. The neighboring node may be an end user, another toll-based router 206 or an outside network 114. The toll-based router 206 may also send 310 the one or more data packets 218 to the selected neighboring node. In other words, the one or more data packets 218 may be routed via a lower-cost route or a higher-quality (e.g., faster) route depending on the sending (or receiving) node's 102 (104) user preferences 224 entered with a toll service 108.

The toll-based router 206 may also send 312 a routing report 236 to a toll service 108 that indicates routing of the one or more data packets 218. The routing report 236 may include a summary of the routing performed with some proof of routing, e.g., the most recently sent packet 238 (most recently received) that includes a user's signature 242 and a data total 240. The toll-based router 206 may also receive 314 payment for routing the one or more data packets 218. This may include a toll service 108 receiving the routing report 236 and sending a payment report 122 to a payment system 110. The payment system 110 may then credit the toll-based router 206 using a method specified by the toll-based router 206 when registering with the toll service 108.

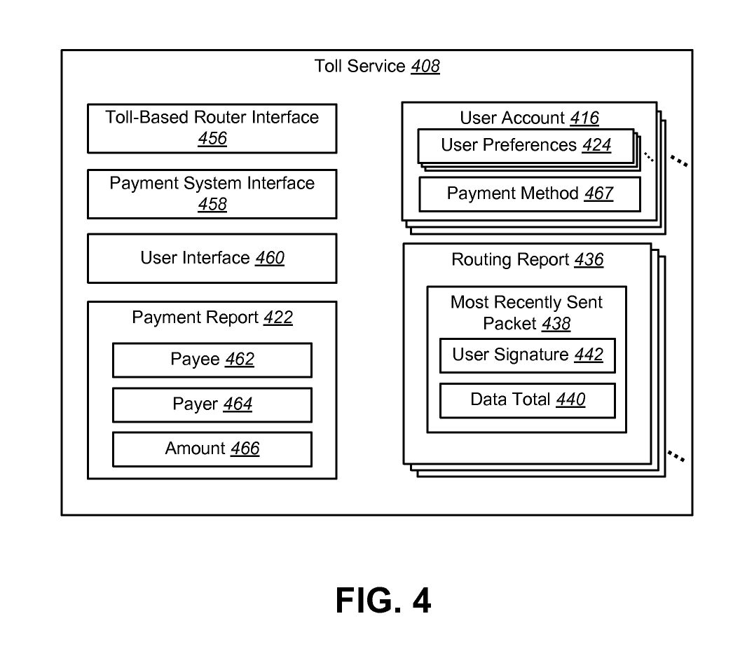

FIG. 4 is a block diagram illustrating a toll service 408. The toll service 408 may include a toll-based router interface 456 that allows it to receive routing reports 436 from a toll-based router 206. A routing report 436 may prove that a toll-based router 206 actually routed specified data packets 218. In one configuration, the routing report 436 may include a most recently sent packet 438 routed that includes the originating user's (or receiving user's) signature 442 and a data total 440. This may serve as a summary of routing performed without unnecessarily consuming bandwidth during reporting.

The toll service 408 may also include a payment system interface 458 that allows it to send a payment report 422 to a payment system 110. In one configuration, the payment report 422 may indicate a payee 462, a payer 464 and an amount 466 for routing a set of data packets 218. The payee 462 may be the party that is owed money for the routing of the data packets 218, i.e., a toll-based router 206. The payer 464 may be the party responsible for paying for the routing of the data packets 218, i.e., the originator or receiver of the data packets 218, or both. The amount 466 may be the amount owed for the routing, less a percentage paid to the toll service 408. In one configuration, the amount owed may be an amount of money. In another configuration, the amount owed may be an amount of credits. The credits may be redeemable for monetary payments by the system 100.

The toll service 408 may also maintain a set of user accounts 416 for users of the toll-based routing system 100. When attempting to access the network, end users may be prompted to register with the toll service 408, e.g., a web browser may be redirected to a toll service 408 login page administered by the user interface 460. If a user account 416 already exists for the user, they may have an opportunity to update their user preferences 424, payment method 467, etc. However, if no user account 416 exists for the user, a new one may be created before the user is able to proceed. User preferences 424 and a payment method 467 may be established during this setup. User preferences 424 may include a preference for a high-quality (e.g., fast) connection even at a higher cost. Alternatively, the user preferences may indicate a preference for low cost even if that means using a lower-quality (e.g., slower) connection. Alternatively, the user preferences may indicate some compromise between quality and cost. For example, a user may prefer a high-quality factor up until a threshold is reached (such as a total charges for a month), or until the cost of using the link exceeds a cost threshold. The user may also have different user preferences 424 based on the type or size of data packets 218 being routed.

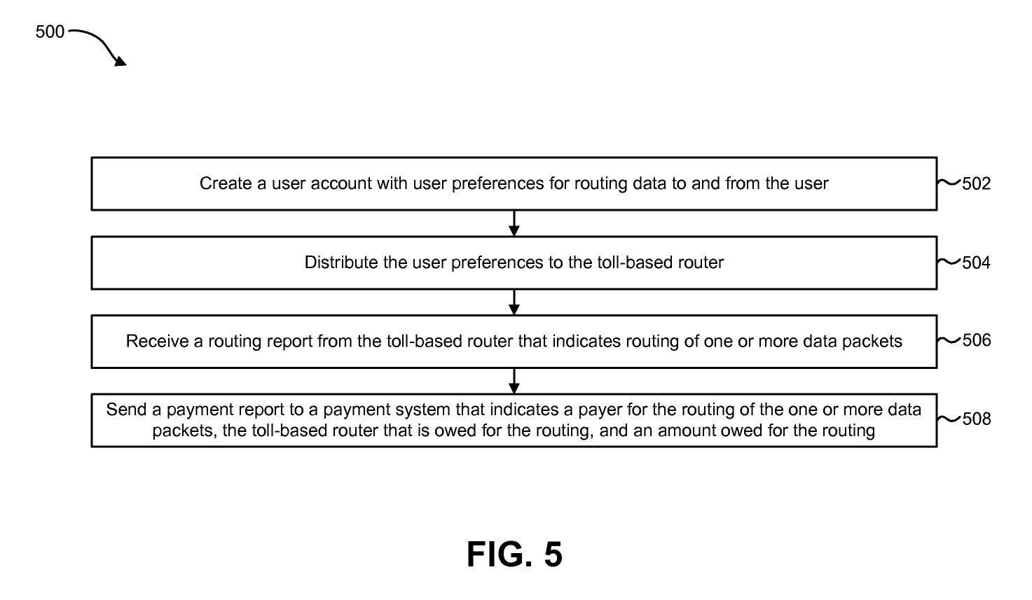

FIG. 5 is a flow diagram illustrating another method 500 for toll-based routing. The method 500 may be performed by a toll service 408 in a toll-based routing system 100. The toll service 408 may create 502 a user account 416 with user preferences 424 for routing data to and from the user. For example, the user may prefer the cheapest possible routing path, even at the expense of speed, such as for an email. Alternatively, the user may desire the fastest possible route, even at a higher cost, such as for streaming video.

The toll service 408 may distribute 504 the user preferences 424 to a toll-based router 206. This, along with a routing table 228, may allow the toll-based router 206 to determine a path for data packets 218 sent to or from the user. The toll service 408 may also receive 506 a routing report 436 from the toll-based router 206 that indicates routing of one or more data packets 218. The routing report 436 may be a summary of the routing performed. The toll service 408 may also send 508 a payment report 422 to a payment system 110 that indicates a payer 464 for the routing of the one or more data packets 218, the payee 462 (e.g., toll-based router 206) that is owed for the routing and the amount 466 owed for the routing. The payment system 110 may periodically receive and distribute payments to the participating nodes and toll-based routers 106a-d.

In one configuration, the toll service 408 may aggregate routing reports 436 for each user and for each toll-based router 206 during a billing period, e.g., once a month. For example, the toll service 408 may aggregate all of the routing reports provided by all the toll-based routers 206 in a network for each user during a billing period. The toll service 408 may charge the user for all of the routing services consumed during a billing period. The toll service 408 may submit a payment report 422 to the payment system 110 that indicates the user as the payer 464, the toll service 408 as the payee 462 and an amount 466 that represents all of the routing services used by the user on any toll-based router 206 during that billing period. The toll service 408 may also aggregate all of the routing reports 436 provided by a particular toll-based router 206 for all users that the toll-based router 206 has routed traffic for during the billing period. The toll service 408 may submit a payment report 422 to the payment system 110 that indicates the toll service 408 as the payer 464, the toll-based router 206 as the payee and an amount 466 that represents all of the routing services provided by the toll-based router 206 to all users during that billing period. The toll service 408 may charge both the users and the toll-based routers 206 a fee for this service. The fee may be deducted from the amount 466 the toll service 408 pays to the toll-based routers 206 and may be added to the amount the user pays to the toll service 408.

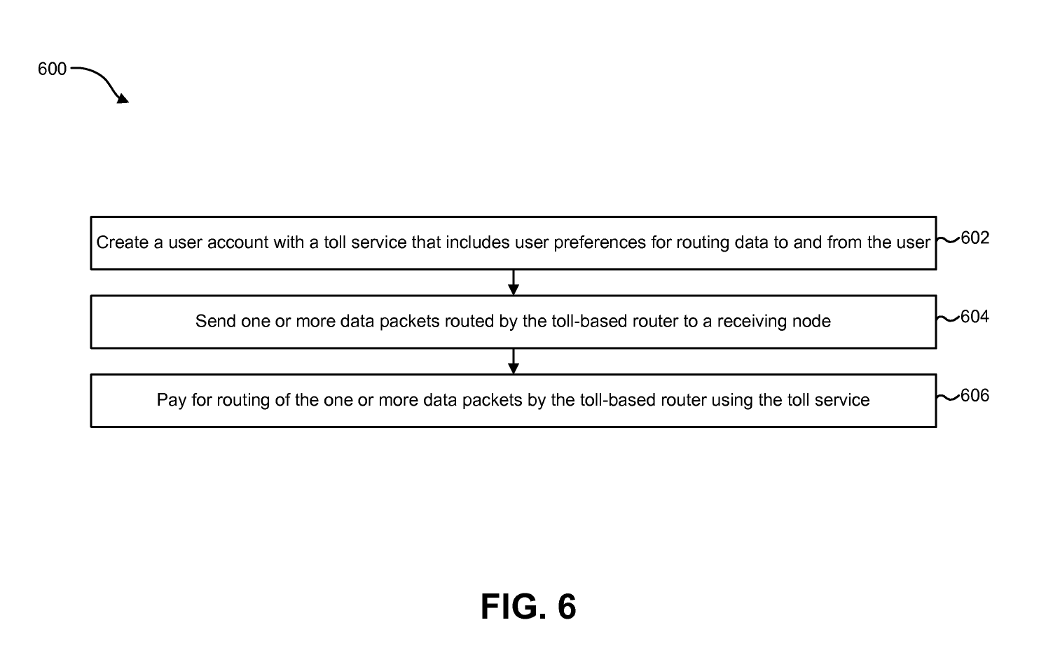

FIG. 6 is a flow diagram illustrating a method 600 for toll-based routing. The method may be performed by a sending node 102 in a toll-based routing system 100. The sending node 102 may create 602 a user account 416 with a toll service 408 that includes user preferences 424 for routing data to and from the user. The user preferences 424 may specify a preference for the cheapest possible routing path, even at the expense of speed, such as for an email. Alternatively, the user preferences may specify a preference for the fastest possible route, even at a higher cost, such as for streaming video. The sending node 102 may also send 604 one or more data packets 218 routed by the toll-based router 206 to a receiving node 104. Sending the one or more data packets 218 may include transmitting the one or more data packets 218 over a virtual network interface on the sending node 102 to the toll-based router 206. The sending node 102 may also pay 606 for the routing of the one or more data packets 218 by the toll-based router 206 using the toll service 408 and the payment system 110.

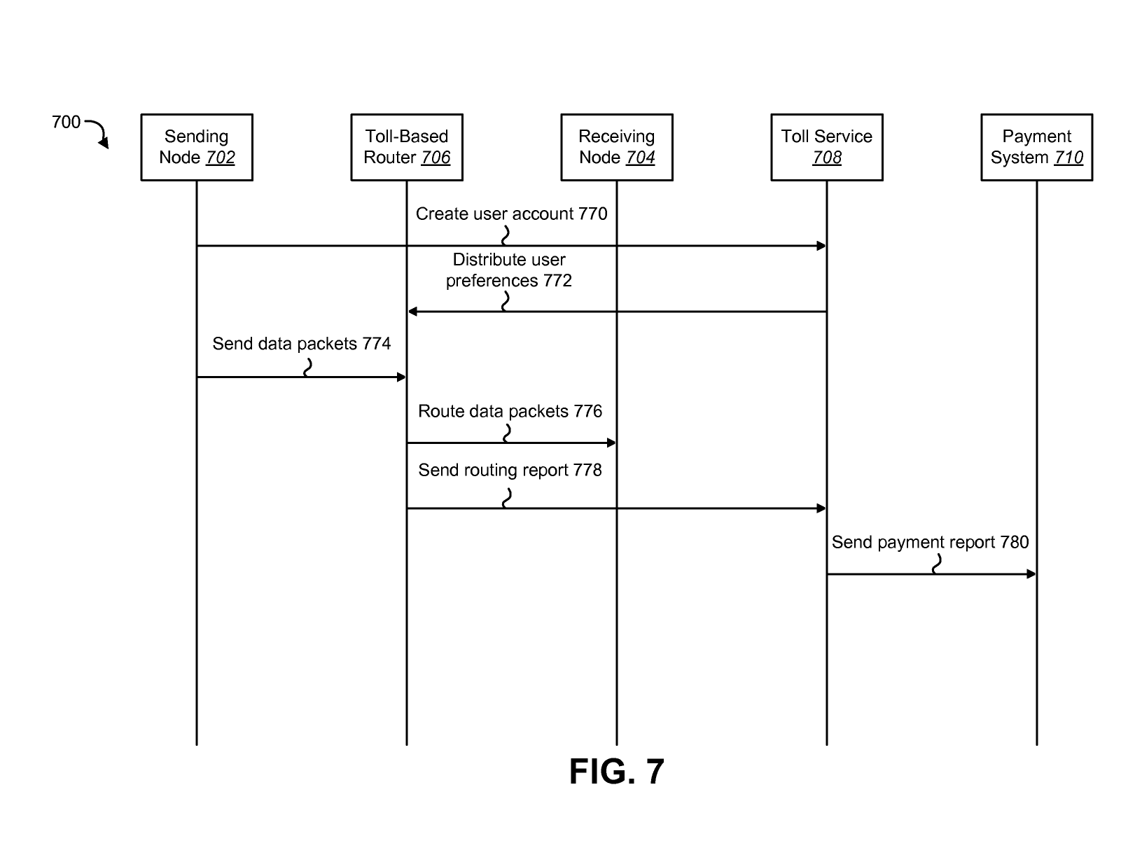

FIG. 7 is a sequence diagram 700 illustrating the interactions between the components of a system that uses toll-based routing. The system may include a sending node 702, a toll-based router 706, a receiving node 704, a toll service 708 and a payment system 710. The sending node 702 may create 770 a user account 416 with the toll service 708. This may include receiving input from the user through a user interface 460.

In one configuration, the user interface 460 may include a toll system web page. In this configuration, the toll service 408 may direct a web browser of the user to the web page. The web page may allow the user to provide input about a payment method 467. For example, the web page may allow the user to indicate that payment should be made by charging or crediting the user's credit card account, bank account, online payment service account (e.g., PAYPAL™), etc. The web page may also allow the user to indicate user preferences 424 for routing data to and from the user. The user preferences 424 may indicate a preference for low-cost routing or high-speed routing. Low-cost routing may indicate a preference that traffic be routed along the cheapest possible path, even at the expense of speed. This might be desirable, for example, when sending an email. High-speed routing may indicate a preference that traffic be routed along the fastest possible path, even at a higher cost. This might be desirable, for example, when streaming video. The payment method 467 and the user preferences 424 may be associated with the user account 416.

The toll service 708 may distribute 772 the user preferences 424 associated with the sending node's 702 user account 416 to the toll-based router 706. The toll-based router 706 may use the user preferences 424 along with a routing table 228 to route data packets 218 sent from the sending node 702. In one configuration, the traffic generated over the local network 112 to create the user account 416 and to distribute the user preferences 424 may be free to the user. That is, the user may not be charged for traffic routed over the local network 112 to and from the toll service 708.

The sending node 702 may send 774 one or more data packets 218 to the toll-based router 706. Sending the one or more data packets 218 may include transmitting the one or more data packets 218 over a virtual network interface on the sending node 702 to the toll-based router 706. The toll-based router 706 may then route 776 the one or more data packets 218 to the receiving node 704. The toll-based router 706 may route the one or more data packets 218 based on the user preferences 424 and a routing table 228. The routing table 228 may associate a cost 232 and a quality factor 234 with each destination in the local network 112.

In one configuration, if the user preferences 424 indicate a preference for low-cost routing, then the toll-based router 706 may select a least-cost path to the receiving node 704 and may send the one or more data packets 218 to a node that neighbors the toll-based router 706 that is in the least-cost path. The neighboring node may be another toll-based router 706 in the local network 112 or it may be a node in an outside network 114. A node may neighbor the toll-based router 706 if the node is reachable over a network from the toll-based router 706 without any intermediary hops. A path is a series of hops that the one or more data packets 218 may traverse to travel from the toll-based router 706 to a destination 230. A node may be in a path if the one or more data packets 218 traverse the node to reach the destination 230 along the path. A path may be a least-cost path if the routing charges incurred to reach the receiving node 704 along the path are the least expensive of all the possible paths to the receiving node 704 from the toll-based router 706. Alternatively, a least-cost path may be the least expensive of all the paths considered by the toll-based router 706. The routing charges may be determined based on the cost 232 in the routing table 228 associated with each destination 230 in the path. There may be several least-cost paths available from the toll-based router 706 to the receiving node 704 if there are several paths that have the same lowest cost. In one configuration, the toll-based router 706 selects the fastest of the least-cost paths based on the quality factor 234 in the routing table 228 associated with each of the destinations 230 along each least-cost path.

In another configuration, if the user preferences 424 indicate a preference for high-speed routing, then the toll-based router 706 may select a fastest path. A fastest path may be a highest-quality path of all the possible paths to the receiving node 704 from the toll-based router 706. Alternatively, a fastest path may be the highest-quality path of all the paths considered by the toll-based router 706. The routing quality may be determined based on the quality factor 234 in the routing table 228 associated with each destination 230 in the path. There may be several fastest paths that have the same highest quality. In one configuration, the toll-based router 706 selects the cheapest of the fastest paths based on the cost 232 in the routing table 228 associated with each of the destinations 230 along each fastest path.

If the receiving node 704 is reachable through an outside network 114, the toll-based router 706 may select a path that travels through the outside network 114, through the local network 112, or both. The routing table may include a cost 232 and a quality factor 234 to reach a destination 230 in the outside network 114. The toll-based router 706 may use the cost 232 and quality factor 234 in the routing table 228 associated with the destination 230 in the outside network when selecting the path to the receiving node 704. Thus in one configuration, the determination of whether to send the data packets 218 over the outside network 114 may be made in the same manner as when determining a path over the local network 112.

The toll-based router 706 may then send 778 a routing report 236 to the toll service 708. The routing report 236 may indicate routing of the one or more data packets 218 from the sending node 702 to the receiving node 704. The routing report 236 may include a most recently sent packet 238 routed by the toll-based router 706. The most recently sent packet 238 may include a user signature 242 of the sending node 702 and a data total 240 of the one or more data packets 218. The toll service 708 may then send 780 a payment report 422 to the payment system 710. The payment report 422 may indicate a payer 464 for the routing of the one or more data packets 218, the payee 462 that is owed for the routing, and an amount 466 owed for the routing. In one configuration, the payer 464 is the sending node 702 and the payee 462 is the toll-based router 706. In this manner, the toll-based router 706 may be paid by the sending node 702 for routing the one or more data packets 218. The amount 466 of the payment may be calculated based on the data total 440 in the routing report 436.

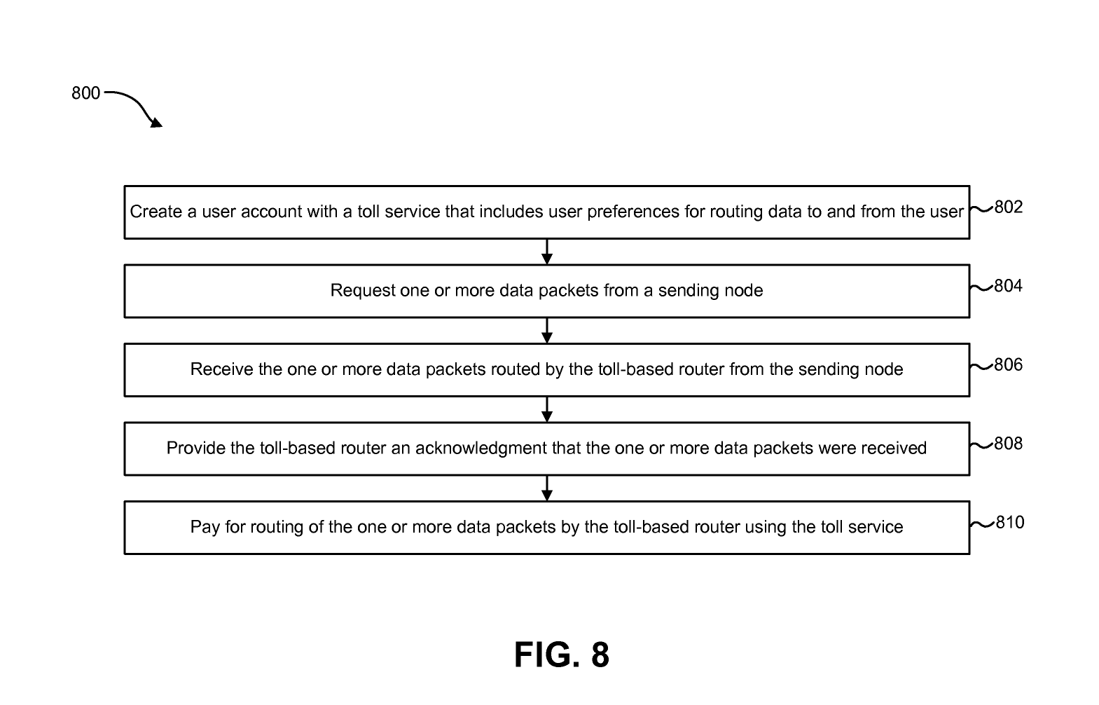

FIG. 8 is a flow diagram illustrating a method 800 for toll-based routing. The method 800 may be performed by a receiving node 104 in a toll-based routing system 100. The receiving node 104 may create 802 a user account 416 with a toll service 408 that includes user preferences 424 for routing data to and from the user. The user preferences 424 may specify a preference for the cheapest possible routing path, even at the expense of speed, such as for an email. Alternatively, the user preferences 424 may specify a preference for the fastest possible route, even at a higher cost, such as for streaming video.

The receiving node 104 may also request 804 one or more data packets 218 from a sending node 102. The receiving node 104 may also receive 806 the one or more data packets 218 routed by the toll-based router 206 from the sending node 102. The receiving node 104 may also provide 808 the toll-based router 206 an acknowledgment that the one or more data packets 218 were received. The receiving node 104 may also pay 810 for the routing of the one or more data packets 218 by the toll-based router 206 using the toll service 208 and the payments system 110.

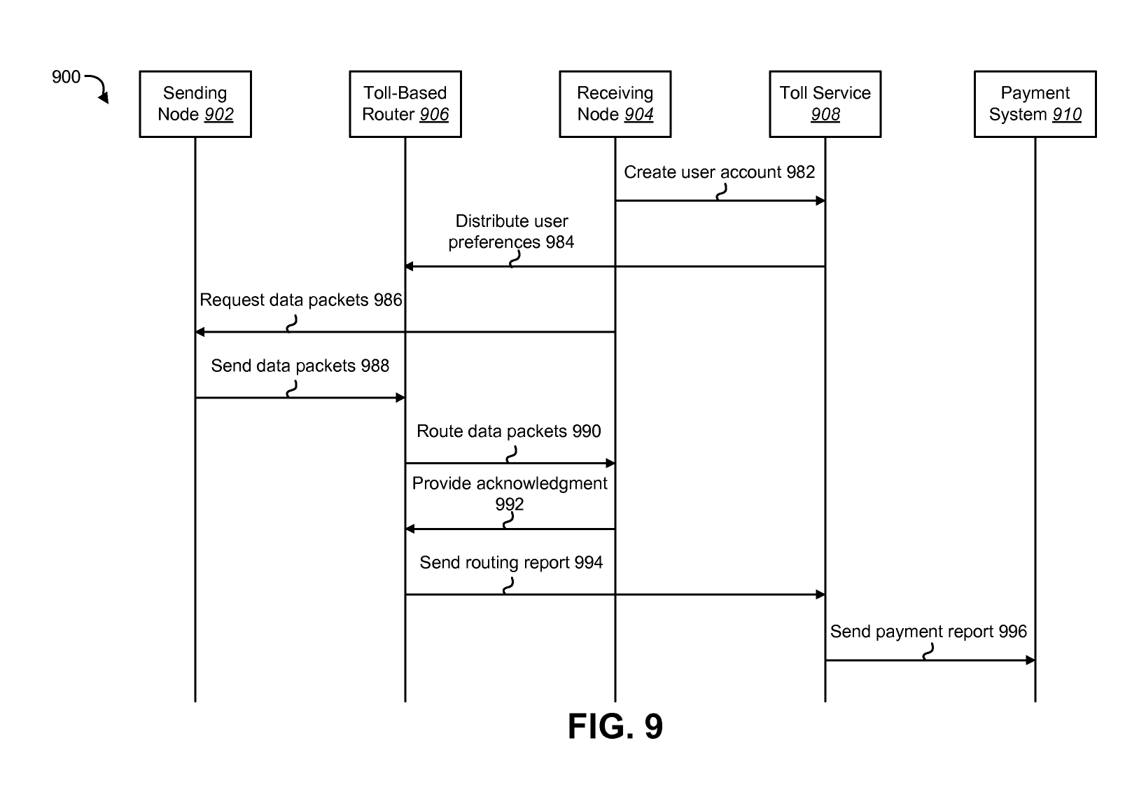

FIG. 9 is a sequence diagram 900 illustrating the interactions between the components of a system that uses toll-based routing. The system may include a sending node 902, a toll-based router 906, a receiving node 904, a toll service 908 and a payment system 910. The receiving node 904 may create 982 a user account 416 with the toll service 908. Creating a user account 416 may include receiving input from the user through a user interface 460. In one configuration, the user interface 460 may include a toll system web page that may operate similar to the toll system web page described in the discussion of FIG. 7.

The toll service 908 may distribute 984 the user preferences 424 associated with the receiving node's 904 user account 416 to the toll-based router 906. The toll-based router 906 may use the user preferences 424 along with a routing table 228 to route data packets 218 received by the receiving node 904. This may be done in a manner similar to that described in the discussion of FIG. 7. The receiving node 904 may request 986 one or more data packets 218 from the sending node 902. The sending node 902 may then send 988 the one or more data packets 218. The one or more data packets 218 may eventually reach the toll-based router 906 after travelling over the local network 112, the outside network 114 or both. The toll-based router 906 may then route 990 the data packets 218 to the receiving node 904 based on the routing table 228 and the user preferences 424. The receiving node 904 may provide 992 the toll-based router 906 an acknowledgment that the one or more data packets 218 were received. In one configuration, the acknowledgment may be a most recently sent packet 238 received that includes the receiving node's 904 user signature 242 and a data total 240 of the one or more data packets 218 received. The toll-based router 906 may then send 994 a routing report 236 to the toll service 908 that may be similar to the routing report 236 described in the discussion of FIG. 7. The toll service 908 may then send 996 a payment report 422 to the payment system 910 that may be similar to the payment report 422 described in the discussion of FIG. 7. In one configuration, the payer 464 may be the receiving node 904 and the payee 462 may be the toll-based router 906. In this manner, the toll-based router 906 may be paid by the receiving node 904 for routing the one or more data packets 218. The amount of the payment may be calculated based on the data total 440 in the routing report 436.

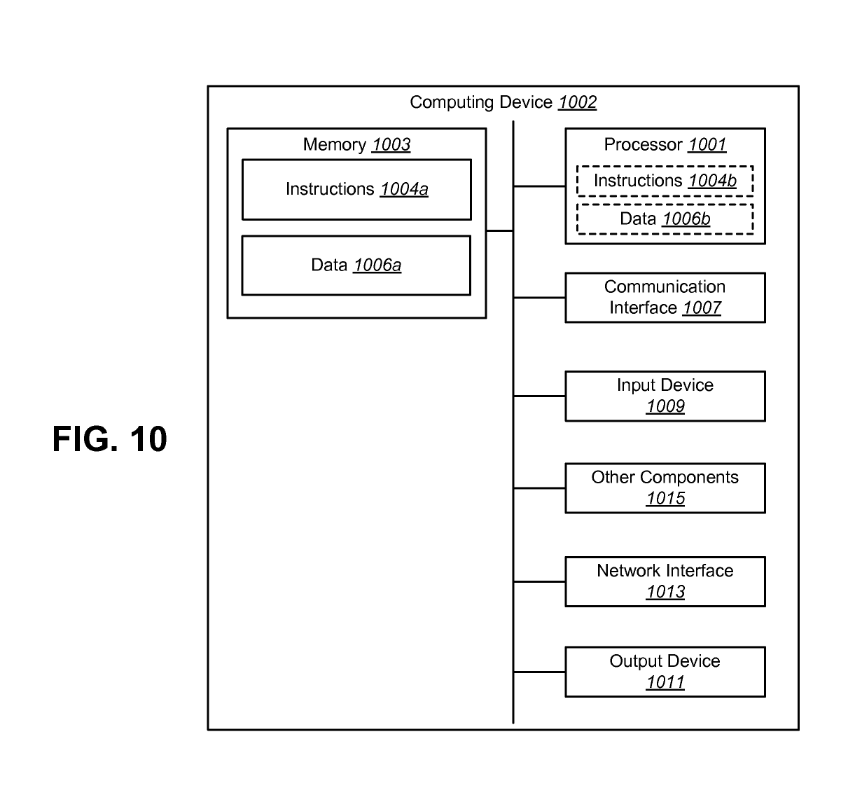

FIG. 10 is a block diagram illustrating various components that may be utilized in a computing device 1002. The computing device 1002 may be a sending node 102, a receiving node 104, a toll-based router 106a-d, a toll service 108 or a payment system 110. Although only one computing device 1002 is shown, the configurations herein may be implemented in a distributed system using many computer systems. Computing devices 1002 may include the broad range of digital computers, including microcontrollers, hand-held computers, personal computers, servers, mainframes, supercomputers, minicomputers, workstations and any variation or related device thereof.

The computing device 1002 is shown with a processor 1001 and memory 1003. The processor 1001 may control the operation of the computing device 1002 and may be embodied as a microprocessor, a microcontroller, a digital signal processor (DSP) or other device known in the art. The processor 1001 typically performs logical and arithmetic operations based on program instructions 1004a stored within the memory 1003. The instructions 1004a in the memory 1003 may be executable to implement the methods described herein.

The computing device 1002 may also include one or more communication interfaces 1007 and/or network interfaces 1013 for communicating with other electronic devices. The communication interface(s) 1007 and the network interface(s) 1013 may be based on wired communication technology and/or wireless communication technology.

The computing device 1002 may also include one or more input devices 1009 and one or more output devices 1011. The input devices 1009 and output devices 1011 may facilitate user input/user output. Other components 1015 may also be provided as part of the computing device 1002.

Data 1006a and instructions 1004a may be stored in the memory 1003. The processor 1001 may load and execute instructions 1004b from the instructions 1004a in memory 1003 to implement various functions. Executing the instructions 1004a may involve the use of the data 1006b that is loaded from the memory 1003. The instructions 1004a are executable to implement one or more of the processes or configurations shown herein, and the data 1006a may include one or more of the various pieces of data described herein.

The memory 1003 may be any electronic component capable of storing electronic information. The memory 1003 may be embodied as random access memory (RAM), read-only memory (ROM), magnetic disk storage media, optical storage media, flash memory devices in RAM, on-board memory included with the processor, EPROM memory, EEPROM memory, an ASIC (Application Specific Integrated Circuit), registers, and so forth, including combinations thereof.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 3, 5, 6, and 8, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods and apparatus described herein without departing from the scope of the claims.

What is claimed is:

1. A method for toll-based routing, comprising:
building a routing table that associates a cost and a quality factor with each destination in a network;
receiving one or more data packets;
selecting a neighboring node to send the one or more data packets based on the routing table and user preferences of an originator or intended receiver of the one or more data packets;
sending the one or more data packets to the selected neighboring node; and
sending a routing report to a toll service that indicates routing of the one or more data packets.

2. The method of claim 1, further comprising receiving payment for routing the one or more data packets.

3. The method of claim 1, further comprising receiving the user preferences from the toll service.

4. The method of claim 1, wherein the user preferences indicate a preference for low-cost routing or high-speed routing.

5. The method of claim 1, wherein the routing report comprises a data total of the one or more data packets from a most recently sent packet in the one or more data packets, wherein the most recently sent packet comprises a signature of an originator of the one or more data packets.

6. The method of claim 1, wherein the network is a mesh network.

7. An apparatus for toll-based routing, comprising:
a processor;
memory in electronic communication with the processor;
instructions stored in the memory, the instructions being executable to:
build a routing table that associates a cost and a quality factor with each destination in a network;
receive one or more data packets;
select a neighboring node to send the one or more data packets based on the routing table and user preferences of an originator or intended receiver of the one or more data packets;
send the one or more data packets to the selected neighboring node; and
send a routing report to a toll service that indicates routing of the one or more data packets.

8. The apparatus of claim 7, wherein the instructions are further executable to receive payment for routing the one or more data packets.

9. The apparatus of claim 7, wherein the instructions are further executable to receive the user preferences from the toll service.

10. The apparatus of claim 7, wherein the user preferences indicate a preference for low-cost routing or high-speed routing.

11. The apparatus of claim 7, wherein the routing report comprises a data total of the one or more data packets from a most recently sent packet in the one or more data packets, wherein the most recently sent packet comprises a signature of an originator of the one or more data packets.

12. The apparatus of claim 7, wherein the network is a mesh network.

13. A method for toll-based routing, comprising:
creating a user account with user preferences for routing data to and from a user;
distributing the user preferences to a toll-based router;
receiving a routing report from the toll-based router that indicates routing of one or more data packets; and
sending a payment report to a payment system that indicates a payer for the routing of the one or more data packets, the toll-based router that is owed for the routing, and an amount owed for the routing.

14. The method of claim 13, wherein the creating comprises:
directing a web browser of the user to a toll system web page;
receiving input from the user about a payment method; and
receiving the user preferences for routing data to and from the user.

15. The method of claim 13, wherein the user preferences indicate a preference for low-cost routing or high-speed routing.

16. The method of claim 13, wherein the routing report comprises a most recently sent packet in the one or more data packets and a data total of the one or more data packets, wherein the most recently sent packet comprises a signature of an originator of the one or more data packets.

17. An apparatus for toll-based routing, comprising:
a processor;
memory in electronic communication with the processor;
instructions stored in the memory, the instructions being executable to:
create a user account with user preferences for routing data to and from a user;
distribute the user preferences to a toll-based router;
receive a routing report from the toll-based router that indicates routing of one or more data packets; and
send a payment report to a payment system that indicates a payer for the routing of the one or more data packets, the toll-based router that is owed for the routing, and an amount owed for the routing.

18. The apparatus of claim 17, wherein the creating comprises:
directing a web browser of the user to a toll system web page;
receiving input from the user about a payment method; and
receiving the user preferences for routing data to and from the user.

19. The apparatus of claim 17, wherein the user preferences indicate a preference for low-cost routing or high-speed routing.

20. The apparatus of claim 17, wherein the routing report comprises a most recently sent packet in the one or more data packets and a data total of the one or more data packets, wherein the most recently sent packet comprises a signature of an originator of the one or more data packets.
